(19) United States
(12) Patent Application Publication
(10) Pub. No.: US 2005/0077845 A1
(43) Pub. Date: Apr. 14, 2005

(54) Actively controlled harmonic force generator

(76) Inventors: Nejat Olgac, Coventry, CT (US); Oldrich Mikus, Prague (CZ); Rifat Sipahi, Storrs, CT (US)

Correspondence Address: Attn.: Anita Lomartra;McCARTER & ENGLISH, LLP, CityPlace I, 185 Asylum Street, Hartford, CT, 06103, US

(21) Appl. No.: 10/923,390

(22) Filed: Aug. 20, 2004

Related U.S. Application Data
(60) Provisional application No. 60/499,125, filed on Aug. 29, 2003.

(51) Int. Cl. H02P 1/54

(52) U.S. Cl. 318/34; 318/611

(57) ABSTRACT

A “harmonic force generator” (HFG) is provided which creates counter-acting forces to a harmonic excitation. The advantageous HFG devices of the present disclosure may be used in canceling the undesired vibrations on a structure under the influence of a harmonic excitation. There are critical aspects to be controlled in the output force: the amplitude, the frequency and the relative phase with respect to given harmonic signal. All three of these components are adjusted by a closed loop control structure according to the present disclosure. The controller determines the transition time of all three features. The disclosed HFG advantageously produces this harmonically varying force only along a determined axis, with no force component in transverse direction.

### CROSS-REFERENCE TO RELATED APPLICATIONS

The present application claims the benefit of a co-pending, commonly assigned provisional patent application entitled “Actively Controlled Harmonic Force Generator,” which was filed on Aug. 29, 2003 and assigned Ser. No. 60/499,125. The entire contents of the foregoing provisional patent application are incorporated herein by reference.

### TECHNICAL FIELD

The present disclosure is directed to force generators that are adapted for harmonic operation and that permit advantageous control of amplitude, frequency and phase angle.

### BACKGROUND OF THE DISCLOSURE

Electromagnetic shakers (also known as voice coil actuators) are commonly utilized for computer controlled force applications. When the force trace becomes harmonic, the devices which use rotating eccentric masses are more feasible to operate. If one wishes to vary three descriptors, the amplitude, frequency and the phase angle of these harmonics, the design and the operation of such devices becomes more challenging.

The technical literature provides background information concerning prior development efforts directed to counteracting vibrational forces associated with harmonic excitation of structures, especially in the rotorcraft industry. The following publications generally fall within the technical field of the present disclosure:
Chopra, I., “Status of Application of Smart Structures Technology to Rotorcraft Systems,” Journal of the American Helicopter Society, 45(4): 228-252, October, 2000.
Chen, P. C., “Wind Tunnel Test of a Smart Rotor Model with Individual Blade Twist Control,” Journal of Intelligent Material Systems and Structures, 8(5): 414-425, May, 1997.
Crawley, E. F., “Intelligent Structures for Aerospace: A Technology Overview and Assessment,” AIAA Journal, Vol. 32, No. 8, August, 1994.
Liaw, C. et al., “Random Vibration Test Control of Inverter-Fed Electrodynamic Shaker,” IEEE Transactions on Industrial Electronics, Vol. 49, No. 3: 587-594, June, 2002.
To, W. M. et al., “A Closed-Loop Model for Single/Multi-Shaker Modal Testing,” Mechanical Systems and Signal Processing, Vol. 5, No. 4: 305-316, July, 1991.
Varota, P. S. et al., “Interaction Between a Vibration Exciter and the Structure Under Test,” Sound and Vibration, Vol. 36, No. 10: 20-26, October, 2002.

The patent literature also includes teachings that relate to prior attempts to address harmonic vibration issues. Patents of background interest to the present disclosure are U.S. Pat. No. 4,236,607 to Halwes et al. (“Vibration Suppression System”), U.S. Pat. No. 5,347,884 to Garnjost et al. (“Method and Apparatus for Cancellation of Rotational Unbalance”), U.S. Pat. No. 5,620,068 to Garnjost et al. (“Method and Apparatus for Actively Adjusting and Controlling a Resonant Mass-Spring System”), and U.S. Pat. No. 5,903,077 to Garnjost et al. (“Modular Vibratory Force Generator and Method of Operating Same”).

Despite efforts to date, a need remains for an harmonic force generator that provides for enhanced control and operation, while accommodating desired variations in amplitude, frequency and phase angle. It is also desired to provide an harmonic force generator that provides improved transition trajectory, e.g., to prevent controller shocks. In addition, a need exists for an harmonic force generator that may be operated with an existing prime mover, e.g., based on a rotating shaft input. It is further desired to provide an harmonic force generator that is light weight, compact and effective in conserving rotational momentum. It is additionally desired to provide an harmonic force generator that minimizes total harmonic distortion, e.g., by combating gravity effects.

These and other objects are achieved through an advantageous harmonic force generator as described herein. Other benefits and functional advantages of the disclosed harmonic force generator will be apparent to persons skilled in the art from the detailed description which follows, and such additional benefits/functional advantages are expressly within the scope of the present disclosure.

### SUMMARY OF THE DISCLOSURE

A novel harmonic force generator and associated control system are disclosed herein to achieve the desired objects with a very favorable ratio between the peak force and device weight. The variation in the force amplitude may be taken from zero to Fₘₐₓ, while the frequency range varies about ±10% around the nominal operating frequency. Indefinite variations of relative phase angle (i.e., zero to 2π) with respect to a given harmonic signal can be achieved using the disclosed device. The transition from a set of the three descriptors, i.e., amplitude, frequency and phase angle, to another descriptor set is achieved under an open loop control of the device. The disclosed device has numerous advantageous applications, including applications wherein it is desired to generate harmonic force excitations, and in mission critical applications, e.g., for canceling vibration caused by quasi-static harmonic forces.

A “harmonic force generator” (HFG) is a device which creates counter-acting forces to a harmonic excitation. The advantageous HFG devices of the present disclosure may be used in canceling the undesired vibrations on a structure under the influence of a harmonic excitation. There are critical aspects to be controlled in the output force: the amplitude, the frequency and the relative phase with respect to given harmonic signal. All three of these components are adjusted by a closed loop control structure according to the present disclosure. The controller determines the transition time of all three features. The HFG advantageously produces this harmonically varying force only along a determined axis, with no force component in transverse direction.

Additional advantageous features and functions of the disclosed HFG devices will be apparent from the detailed description which follows, particularly when taken in conjunction with the figures appended hereto.

### BRIEF DESCRIPTION OF FIGURE(S)

So that those having ordinary skill in the field to which the present disclosure appertains will better understand how to make and use the disclosed HFG technology, reference is made to the accompanying figures, wherein:

FIG. 1a is a three-dimensional rendering of an exemplary harmonic force generator according to the present disclosure;

FIG. 1b is schematic cross-sectional view of an exemplary harmonic force generator as disclosed herein;

FIGS. 2a and 2b are graphical depictions associated with modes of operation of exemplary harmonic force generators according to the present disclosure;

FIG. 3 is a graphical depiction related to a single rotating mass in a transient mode;

FIG. 4 is a graphical depiction of force transition and a desired force envelope;

FIG. 5 is a logic flow chart for a planning path according to an embodiment of the present disclosure;

FIG. 6 is a schematic illustration of an exemplary control system for an harmonic force generator according to the present disclosure;

FIG. 7 is a photographic view of a prototype harmonic force generator according to the present disclosure;

FIG. 8a is a time trace of forces related to operation of an exemplary harmonic force generator according to the present disclosure;

FIG. 8b includes plots of trajectories for motors #1 and #2 according to the present disclosure;

FIG. 8c is a plot of a Lissajous pattern of a force trace related to an exemplary harmonic force generator according to the present disclosure;

FIG. 9a is a plot of time trace of the force associated with an exemplary harmonic force generator according to the present disclosure;

FIG. 9b are exemplary plots of the trajectory of motor #1; and

FIG. 9c is a plot of a Lissajous pattern of a further force trace according to the present disclosure.

### DETAILED DESCRIPTION OF EXEMPLARY EMBODIMENT(S)

For purposes of the present disclosure, the following nomenclature is used:

| | |
|---|---|
| aᵢ | coefficients of the polynomial for ω trajectory |
| bᵢ | coefficients of the polynomial for φ trajectory |
| F | total force in the direction of the actuation line |
| F₁₃ | force generated by mass 1 and mass 3 in the direction |
| | of the actuation line |
| F₂₄ | force generated by mass 2 and mass 4 in the direction |
| | of the actuation line |
| Fₚₑₐₖ | force amplitude |
| \vec{F} | force vector |
| \vec{F}ₜₒₜₐₗ | total force vector |
| J | the objective function |
| g, \vec{g} | the gravity constant and the gravity field vector |
| m | weight of the single proof mass |
| P₁, P₂ | power for motor # 1 and #2 |
| \vec{r} | local vector |
| T | transition time |
| T_{g} | torque caused by gravity force on the main shaft |
| T₁, T₂ | control torque of motor # 1 and #2 |
| α | the angular position of the single mass |
| η | the force/weight ratio |
| φ | relative angular position (RAP) between masses m₁, |
| | m₃ and m₂, m₄ |
| φᵢ, φ_{f} | initial and final values of relative angular position (RAP) |
| λ₁, λ₂ | weight constants in the objective function |
| ω | angular frequency |
| ωᵢ, ω_{f} | initial and final value of ω |
| ψ | the angle defined as ψ = ωt + θ(t) |
| θ | the absolute phase angle between base reference force |
| | and the output force |
| θᵢ, θ_{f} | initial and final value of θ |
| τ | time constant in the transition |

The “harmonic force generator” (HFG) is a device that creates, as the name implies, harmonic forces exhibiting some desired characteristics. One practical application for HFGs is to deploy the device in canceling the undesired vibrations on a structure under the influence of harmonic excitation(s). There are critical aspects to be controlled in the output of force(s) of an HFG: the amplitude, the frequency and the relative phase with respect to a given harmonic signal. The device should produce this harmonically varying force only along a determined axis, with no force component in transverse direction. By eliminating non-axial force components, the device is effective in avoiding the introduction of secondary excitations, while combating with the primary harmonic excitation.

As is generally the case for mechanical structures, it is desirable to minimize the weight of the device. As a measure of effective weight minimization, the disclosed HFG aims for a high ratio between the maximum force amplitude and the total structural weight. Another important constraint is on the transition time for the peak-to-peak swings in all of the above mentioned properties of the harmonic force. This transition time needs to be desirably small.

A relatively common use of HFGs is as an electromagnetic shaker (i.e., voice coil), which can duplicate the input control signal with relatively high fidelity. But almost all electromagnetic shakers/voice coils are very heavy from the force/weight point of view. This weight issue is primarily due to the presence of a reciprocating proof mass, which reverses its momentum. This operation requires large and heavy electromagnetic force generating structures and actuator masses (proof mass).

According to the present disclosure, the weight issues associated with prior electromagnetic shaker/voice coil systems are advantageously overcome through implementation of centrifugal forces that are created by rotating masses. In the disclosure which follows, a novel HFG design is disclosed/described, controlled trajectories of HFG operation are described, and optimization of the trajectories are disclosed. A unified strategy for HFG control is also disclosed and the results of experimental work validating the advantageous HFG design of the present disclosure are provided.

An Exemplary Device According to the Present Disclosure and its Operation

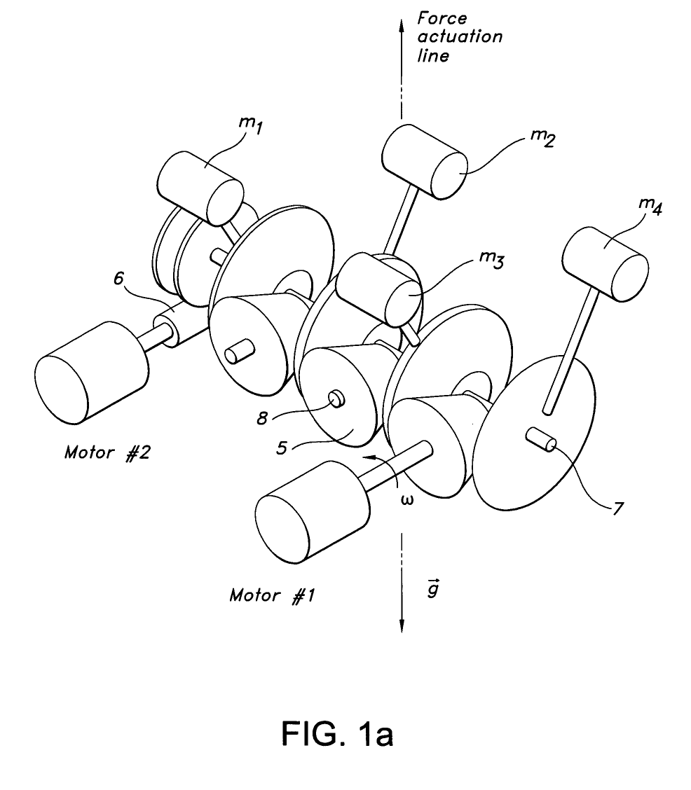

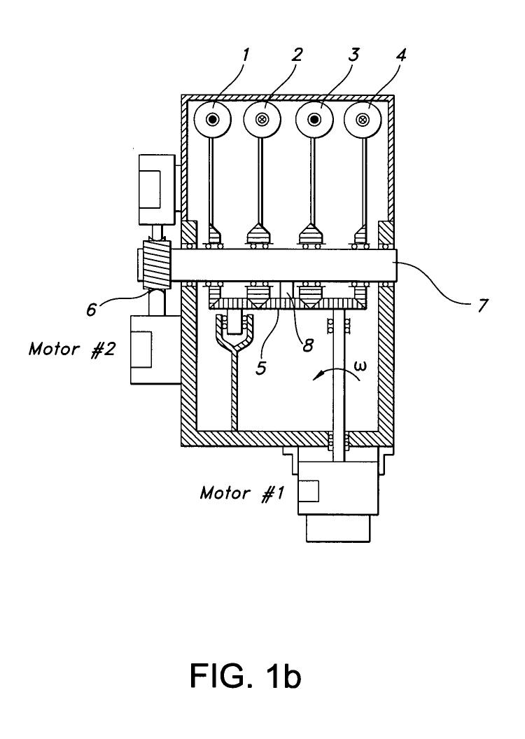

A three dimensional schematic depiction of an exemplary HFG design according to the present disclosure is given in FIG. 1a, along with a cross-sectional view of such exemplary design in FIG. 1b. Four identical rotating masses (marked as m₁ . . . m₄) form the skeleton of the structure. All four masses are attached to conical gears freely rotating about the shaft marked as (7). Motor #1 is the prime mover which rotates all the gears. The idler (also a conical gear) between m₁ and m₂ spins about the axis, which is rigidly fixed to the frame of the HFG. The axis marked as (8) of the second idler (between masses m₂ and m₃) is fixed to the shaft (7). Motor #2 drives this shaft (7) which positions the axis (8).

Four identical masses marked as 1, 2, 3, 4 are depicted in FIG. 1b as though they were all on the plane of the paper for convenience only. Clearly the masses m₁, m₃ and m₂, m₄ rotate in the same direction. Motor 1 creates the torque necessary for rotating all four masses. The conical gear mesh is selected such that all the masses are rotating with the same angular speed, but in different directions, as mentioned. Ideally the rotational speed, ω, remains constant, generating four separate centrifugal forces with equal amplitudes. Masses m₁ and m₂ engender a harmonic force with the angular frequency, ω, along the actuation line of F. Masses m₃ and m₄ yield another harmonic force along the same actuation line, at the same frequency.

If all four masses are instantaneously coincident in the plane of the actuation line, they cause an extrema of force amplitude (min or max). At other operating amplitudes, they should not be on this plane instantaneously. Due to the counter-rotating centrifugal masses, the force components perpendicular to the actuation line cancel each other out, and the in-plane components are added (or subtracted) depending on the instantaneous configuration of the mechanism. The analytical expression representing the force generation will be given in the following text.

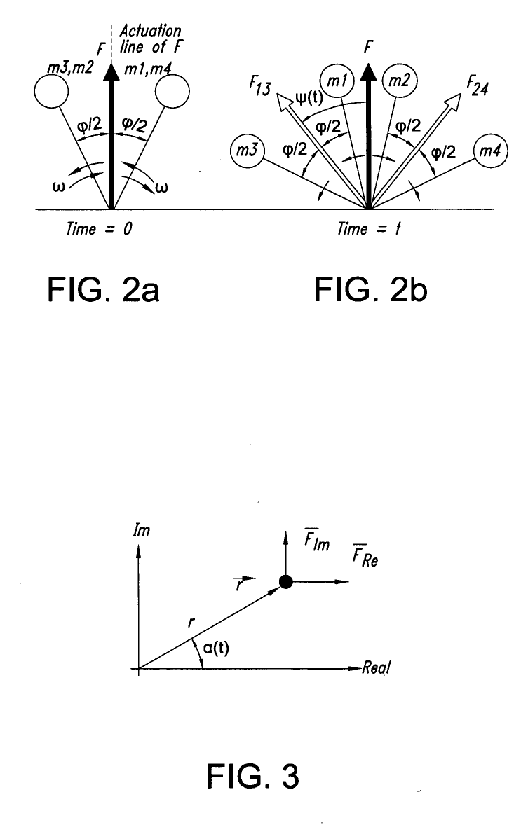

Another feature of counter-rotating masses is of note according to the present disclosure, namely, phase induced amplitude control of the harmonic force. Such amplitude control is achieved by motor #2 and idler (#5). By repositioning the idler, the counter-rotating masses m₁ and m₂ are forced to turn with a phase difference from those of m₃ and m₄. Such repositioning occurs the instant when the masses m₃ and m₄ concurrently pass through the actuation plane of F and the masses m₁ and m₂ are apart from the concurrent m₃ and m₄ by equal angle but on two opposite sides. This causes what may be referred to as “relative angular position” (RAP), φ, as shown in FIGS. 2a and 2b. This RAP (φ) automatically introduces a phase angle, φ, between the two harmonic forces, one created by masses m₁ and m₃, and the other created by masses m₂ and m₄ (i.e., the pairs rotating in the same direction). By controlling the RAP, operation of the advantageous HFG of the present disclosure can establish a wide range of force amplitudes. When φ=0, the four centrifugal forces create the maximum possible amplitude for that ω. And for φ=π, the system would cause zero amplitude of resultant force.

Thus, there are two control inputs to the HFG: (a) speed of motor #1 to control the given angular speed ω, and (b) the rotational position of motor #2 to achieve the desired angular position of the idler axis (8) which ultimately adjusts the RAP. Again, by varying the RAP, the amplitude of the resultant harmonic force is advantageously controlled. The angular speed of motor #1 dictates the frequency of the force.

A third important quantity is the absolute phase angle of the resultant harmonic force relative to the base/harmonic (i.e., reference signal). Such quantity can be adjusted by transient variations on ω. That is, by first slowing the ω and then increasing it back to the starting value will pose a “phase delay” and reverse action a “phase advance”. Both, the delay and the advance is controlled by motor #1, which manipulates the instantaneous angular speed ω(t).

From the design and operational perspectives of the disclosed HFG, the most critical one of the three characteristics of the harmonic force is the amplitude, that is, the adjustment of the RAP. The fundamentals of the operation are depicted in FIG. 2. φ indeed represents the RAP between the two companion masses, i.e., those which turn in the same direction. Masses m₁ and m₃ form one group and m₂ and m₄ the other. Their settings at t=0 and at t=Δt instances are given in FIGS. 2a and 2b, respectively. t=0 corresponds to the instant when the masses 1-4 and 2-3 coincide. As is readily apparent from the foregoing figures, the RAP, φ is a parameter which determines the force amplitude and it is controlled by motor #2.

To further describe operational aspects of an exemplary HFG according to the present disclosure, force variations for cases where the angular velocity is at the steady state (i.e., ω=constant) and in transient (i.e., ω=ω(t)) are provided.

i) Steady State Operation ((ω and φ are Constants).

The angular disposition of each mass, represented by a generic α(t)=ωt, with respect to its starting point is reflected in FIG. 3. This case represents steady operational modes by both motors. The motor #1 is rotating at a constant speed to induce ω and motor #2 is motionless (i.e., φ=constant). In this case the total output force along the actuation line (FIGS. 2a and 2b) is expressed as:
F=(F₁₃+F₂₄)cos ψ(t) (1)

$${F}_{13} = {F}_{24} = 2 m {ω}^{2} r cos \frac{φ}{2} \qquad ( 2 )$$

where the m and r are four identical rotating masses and their eccentricities, respectively. Thus the total force is:

$$F = 4 m {ω}^{2} r cos \frac{φ}{2} cos ψ ( t ) \qquad ( 3 )$$

Obviously the force extremes will occur at instants t={0, π/ω, 2π/ω, 4π/ω, . . . } which correspond to the configuration in FIG. 2a. and a half period later, and so on. Clearly

$${F}_{peak} = 4 m {ω}^{2} r cos \frac{φ}{2} \qquad ( 4 )$$

is the peak force generated. The structural parameters m and r are fixed by design and φ is varied (by motor #2) from 0 to π. This makes Fₚₑₐₖ change from 0 (for φ=π) to 4mω²r (for φ=0). The frequency of F is ω(rad/sec) and it is fixed to the rotational speed of the motor #1 via driver ratio N=ω/ω_{motor#1} in this mode of operation.

ii) Transient Operation

Transient operation exists where neither the angular speed, ω, nor the RAP, φ, is constant, i.e., ω=ω(t) and φ=φ(t). This regime is necessary to vary the frequency of F from one value to another. In fact, the absolute phase angle of the resultant harmonic force can only be adjusted using these transients. In order to analyze the dynamics for this operating regime, it is advantageous to take one rotating mass with time varying angular speed (FIG. 3.). The d'Alambert force generated by this mass is:

$${F}^{->} = - m {r}^{{¨}_{->}} = - m \frac{{ⅆ}^{2}}{ⅆ {t}^{2}} ( {re}^{i α} ) \qquad ( 5 )$$

where \vec{r} is the local vector and i represents the imaginary number in order to engender two dimensional notation in the equation. Real part of the force \vec{F} is taken along the actuation line of the mechanism (shown in FIG. 2.), i.e., in the direction of F, and the imaginary axis is pointing out along the horizontal line of FIG. 2. This is done in order to assure starting points α(0)=0 to be aligned with the actuation line (F), which is depicted schematically in FIG. 3. Equation (5) yields the expression:

$${F}^{->} = - mr [ \ddot{α} {ⅇ}^{ⅈ ( α + \frac{π}{2} )} + {\dot{α}}^{2} {ⅇ}^{ⅈα} ] \qquad ( 6 )$$

Considering the typical mode of operation as depicted in FIG. 2 we observe that the corresponding angles α(t) for the four masses m₁, m₂, m₃, m₄ are

$$ψ - \frac{φ}{2} , - ψ + \frac{φ}{2} , ψ + \frac{φ}{2} , - ψ - \frac{φ}{2} ,$$

respectively. What evolves from (6) is the resultant d'Alambert force out of the motion of all these four masses, which is:

$${{F}^{->}}_{total} = {\sum }_{j = 1}^{4} - mr [ {\ddot{α}}_{j} {ⅇ}^{ⅈ ( {α}_{j} + \frac{π}{2} )} + {\dot{α}}_{j}^{2} {ⅇ}^{{ⅈα}_{j}} ] \qquad ( 7 )$$

It can be proven that expression (7) creates no imaginary part, therefore the only resultant which arises as \vec{F}ₜₒₜₐₗ is in the direction of actuation line of F (in FIG. 2.). This is intuitively obvious from the design, due to the fact that the operation is completely symmetric. Another important observation is that the first terms in (7) are on the perpendicular direction to the local vector of the mass, and they yield the torque requirement on the two motors

$$( {\ddot{α}}_{j} -> \pm \ddot{ψ} ∓ \frac{\ddot{φ}}{2} , j = 1 … 4 ) .$$

Obviously, \ddot{ψ} is to be the term which describes the torque of motor #1 during this maneuver and the

$$\frac{\ddot{φ}}{2}$$

is under the control of motor #2.

Turning to control of the disclosed mechanism, a feed forward control (i.e., open loop control) procedure may be advantageously employed. The control objectives may be reflected under the following symbolic representations:

C1: Control of frequency, ω(t), using motor #1.

C2: Control of phase, θ(t), using motor #1.

C3: Control of the amplitude Fₚₑₐₖ(t), or alternatively control of φ(t), using motor #2.

It is required according to the present disclosure that all three entities are controlled in parallel, i.e., at the same time, not in a sequential manner. The transition from one operating mode to another is completed within a desired transition time, e.g., T. At the beginning and at the end of each transient maneuver, however, two points influence system operation: i) not to introduce jolts (i.e., discontinuous torque requirements) on the motors, and, ii) to minimize the necessary peak power consumption during the transition. The reasons for both of these conditions are simple. Jolts cause unnecessary wear and tear, while the peak torques yield increasing actuator weight. Therefore, in handling the C1+C2+C3 combination, it is advantageous to select the desired tasks of motor #1 and motor #2 through an optimization process.

There are other key issues to be resolved in connection with the operation of exemplary HFGs according to the present disclosure:
a) The gravity disturbance is unavoidable for most HFGs as the masses rotate in the gravity field \vec{g} (see in FIG. 1b). Clearly, gravity assists the rotation as the masses go down, thus easing the control torque, and hinders rotation as the masses go up (i.e., gravity is acting against the control torque). This effect needs to be eliminated using the appropriate counter-torques via motor #1. Otherwise, cyclic fluctuations will appear on the angular speed, ω, which is obviously not desirable. This disturbance torque caused by the gravity field can be expressed as:

$$\begin{matrix}{T}_{gravity} = {T}_{g} \\ = 2 mgr ( sin ( ψ + \frac{φ}{2} ) + sin ( ψ - \frac{φ}{2} ) ) \\ = 4 mgr sin ψ cos \frac{φ}{2}\end{matrix} \qquad ( 8 )$$

which has to be added to the control torque of motor #1. Of note, the range of φ is limited and slowly varying, while ψ is the gross motion of the rotation. Therefore, it is safe to suggest that the gravity effect will carry the oscillatory signature of sin(ψ) which is often referred to as “once-per-revolution” effect.
b) The effect of φ(t) originating from motor #2 has to be considered for the resultant force \overline{F} during the transient regime. It is clearly included in the expression of (7).
   Trajectory Planning for Transient Maneuvers

For all control groups disclosed herein, the path for ψ and φ is determined in such a fashion that enables:
a) the transient to be completed within a desired transition time, T.
b) the two actuators (motors #1 and #2) are required only to execute zero torque at the beginning and at the end of the transition time (i.e., at t=0 and t=T). These conditions can be formalized as in the following, for all those groups of maneuvers.
   C1: ω(t) transient from initial frequency ωᵢ, to the final frequency, ω_{f}.
   C2: phase control, from initial absolute phase θᵢ to final phase θ_{f}, 0≦θᵢ, θ_{f}≦π.

Since the C1 and C2 are executed by a single actuator, i.e., motor #1, the initial and the final values in the maneuvers C1 and C2 can be combined as follows in order to create one single trajectory to fulfill the requirements:

$$Δ θ ( t ) = {{\int }_{0}}^{T} ω ( t ) ⅆ t - {ω}_{i} t$$

(accumulating absolute phase)
where θ(0)=θᵢ and θ(T)=θ_{f}=θᵢ+Δθ(T),
ω(t=0)=ωᵢ, ω(t=T)=ω_{f}
\dot{ω}(t=0)=0, \dot{ω}(t=T)=0 (zero torque jolts) (9)
C3: amplitude control of \overline{F}, by varying φᵢ to φ_{f}, 0≦φᵢ, φ_{f}≦π.
φ(t=0)=φᵢ, φ(t=T)=φ_{f}
\dot{φ}(t=0)=0, \dot{φ}(t=T)=0 (initial and final quiescence)
\ddot{φ}(t=0)=0, \ddot{φ}(t=T)=0 (zero torque) (10)
The C3 (amplitude control) is rendered by motor #2. All three strategies (C1, C2 and C3) are implemented concurrently using the two actuators. To determine the transition path satisfying the conditions (9) and (10), polynomial variations may be employed:
ω(t)=a₅t⁵+a₄t⁴+a₃t³+a₂t²+a₁t+a₀ (11)
φ(t)=b₆t⁶+b₅t⁵+b₄t⁴+b₃t³+b₂t²+b₁t+b₀ (12)
Five of the aᵢ's are evaluated using the five conditions in (9) in terms of 6^{th} aᵢ, and six of the bᵢ's are determined in terms of ₇^{th} bᵢ from six conditions in (10). These two free coefficients represent slack variables of the polynomials, over which the optimization is done, as explained in the next section below. These trajectories set the transition behavior of motors #1 and #2. Since equations (9) and (10) yield simultaneous linear equations, their respective solution for aᵢ and bᵢ can be achieved rapidly. Some examples of such simultaneous solutions are given below. In addition, in the next section a two-dimensional optimization over the slack variables is provided. For the examples disclosed herein, a₆ and b₇ are taken as the slack variables although any one of aᵢ's and bᵢ's could be used.

According to the present disclosure, it is critical to understand and address the cross talk between the three modes of control, i.e., C1, C2 and C3. For instances in which the frequency (ω) is increased to comply with request on C1, the absolute phase (θ) will also be advancing (i.e., C2 action will appear), as well as amplitude variation (i.e., the C3 action), although such resultant variations may not be desired. On the other hand, the frequency variation (C1 action) will bring these secondary effects. The end-point conditions according to the present disclosure introduce proper compensations for this cross talk, and the optimization procedure minimizes the objective function during the transition.

Optimized Trajectories

To further illustrate the advantageous functionalities associated with the disclosed HFGs of the present disclosure, concurrent implementation of C1, C2 and C3 actions are considered. The total harmonic force amplitude varies from an initial value to a final value with a smooth exponential approach. This feature is generically represented as:

$$y ( t ) = {y}_{i} + ( {y}_{f} - {y}_{i} ) ( 1 - {ⅇ}^{- t / τ} ) \qquad ( 13 )$$

where y represents an envelop of the force amplitude. Equation (13) implies that y(t) moves from yᵢ to approximately yᵢ+0.98(y_{f}−yᵢ) within 4τsec, where τ is the commonly known “time constant.” That is, y(t) settles in 4τsec at its new value.

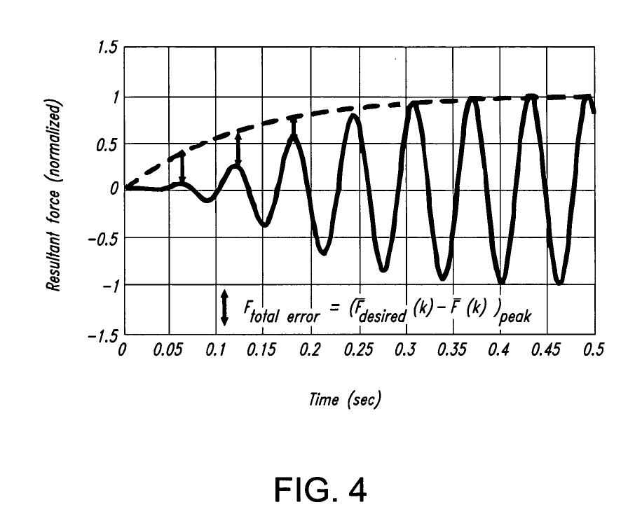

This transition also achieves approximately 67% of the transition in τ sec. Considering the oscillatory nature of total force, Fₜₒₜₐₗ, however, y in (13) represents only the desired envelope of Fₜₒₜₐₗ. The proposed operational trajectories of (11) and (12) are expected to yield considerably different envelopes from the exponential form given by (13). In assessing significance, the errors at the instances when the resultant force Fₜₒₜₐₗ displays a peak should be considered (see in FIG. 4). In order to satisfy the requirements of the smooth start up and end during the transient, the procedure defined by (11) and (12) imposes the Fₜₒₜₐₗ peaks, which may not be in agreement with (13). These discrete point differences (call it the Fₜₒₜₐₗ errors) and the power required to achieve this maneuver form the basis of a trade off. In other words, increased control authority (i.e., increased power consumption) can minimize the error. These two entities can be combined in an objective function (i.e., as a measure of effectiveness). The combined objective function is then minimized to determine optimum transient passage. Considering the above, an objective function to be minimized according to the present disclosure is:

$$J = {λ}_{1} max ( \vert P ( t ) \vert ) + {λ}_{2} {\sum }_{k = 1}^{M} {( {\overline{F}}_{desired} ( k ) - \overline{F} ( k ) )}^{2} \qquad ( 14 )$$

where:

$$P ( t ) = {\sum }_{j = 1}^{4} {I}_{j} {\ddot{α}}_{j} {\dot{α}}_{j}$$

is the power consumption of motor #1,
λ₁ and λ₂ are the appropriate weighting values,
F_{desired} is the discrete values of the exponentially settling force envelope (such as in (13)), and
k denotes the discrete time instants where the output force \overline{F}(t) forms the peak values \overline{F}(k), as shown in FIG. 4.

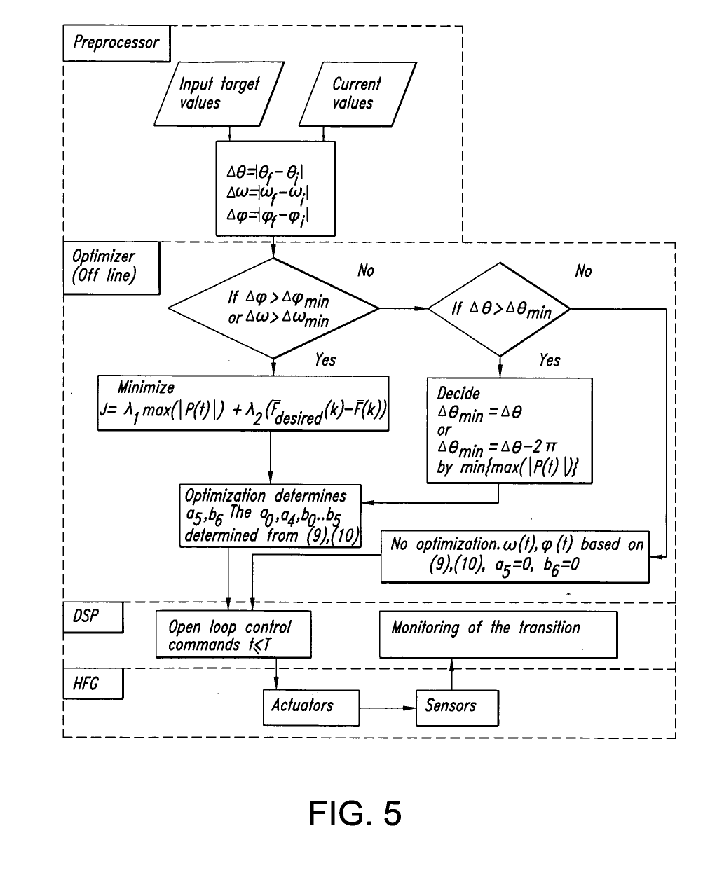

The maximum number of the force peaks \overline{F}(k) in (14), denoted as M, is finite and this is the summation of the force peaks \overline{F}(k) within the transition time. For this objective function, a multi-dimensional optimization is performed over the trajectory parameters a₆ and b₇. It is important to determine the correct ratio of the weights λ₁ and λ₂ based on the preferences on either size of the actuator (i.e., power needs) vs. the trajectory errors. The power of motor #1 forms the large part of the objective function, because it is clear that the power required for motor #2 is negligible due to its small and slow motion. The optimization followed here is represented by a control flow chart in FIG. 5.

The values Δθₘᵢₙ, Δωₘᵢₙ and Δφₘᵢₙ are introduced in order to avoid the optimization procedure when the values Δθ, Δω and Δφ are small, say less than 5% of the entire operating range. For such cases, the input power for motor #1 and #2 is small enough not to require a further optimization. In this case, the highest order terms of the polynomials (11) and (12) are truncated and the coefficients aᵢ, i=0 . . . 4 and bᵢ, i=0 . . . 5 are calculated only, using conditions (9) or (10). The block which follows Δθ>θₘᵢₙ check is of note. If Δθ>Δθₘᵢₙ (especially when Δθ is slightly bigger than π), it is always a question whether the direction of Δθ or Δθ−2π should be followed, both of which result in the same end condition. A quick check of the peak power requirement is suggested to resolve this question.

This control process is followed to bring some guidelines to the transition behavior. Indeed, the procedure reflects typical trajectory planning and open loop control effort. In the next section, exemplary control strategy(ies) for HFGs according to the present disclosure are provided, as well as exemplary performance results.

Control of Exemplary HFGs According to the Present Disclosure

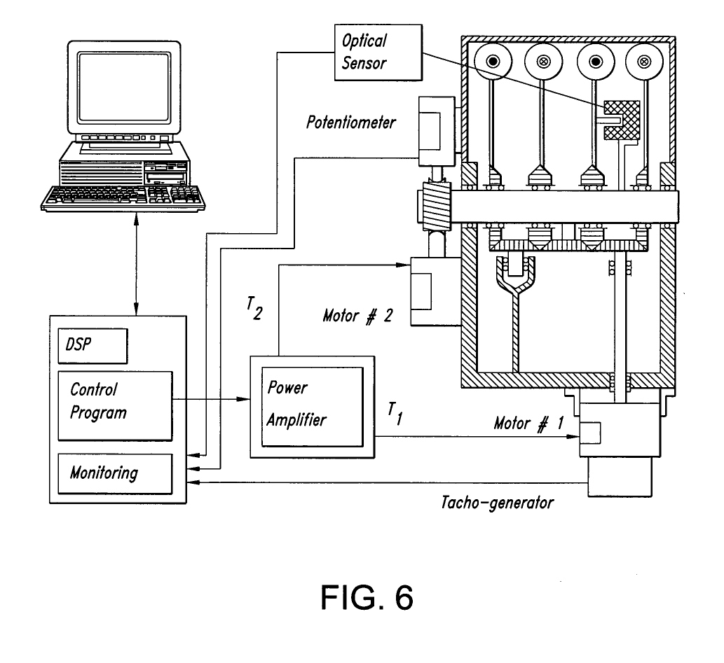

The control of the disclosed HFG and the three characteristic of the output force are advantageously achieved via two DC servo motors. Primarily, both of the motors are controlled in current mode, i.e., their torques are commanded via the controlled current. The three quantities monitored are the speed of motor #1, the angular position of idler (#5), and the force \vec{F}ₜₒₜₐₗ. The speed measurement, for ω, is achieved through a tacho-generator (FIG. 6). A multi-turn potentiometer coupled to the shaft of motor#2 is used to measure φ. The tacho-generator measures the angular velocity of the harmonic force, ω.

Operation of exemplary HFGs according to the present disclosure is performed in the following sequence:

i) The user introduces the target \vec{F}ₜₒₜₐₗ, ω, θ values.

ii) The appropriate trajectories for motor #1 and #2 are evaluated.

iii) Each motor is driven through servo controller, using open loop control.

Controlling the two motors, the amplitude and the frequency of the harmonic force F are materialized. The last item is the phase angle of the harmonic force relative to a baseline harmonic function, i.e., the phase control of the HFG. This part of the control requires a sensor which indicates the instant when the peak of \overline{F} occurs. Such information is very practical to assess the phase difference between the actual force F and the one that is desired. It is a much more practical measure than comparing the time traces of \vec{F}ₜₒₜₐₗ and the baseline harmonics.

The time marks corresponding to the force peaks are obtained using an optical sensor which generally includes a light emitting diode (LED) and a photo detector. The optical sensor is placed between the shaft of the pinion (5) and one of the gears carrying the mass (see detailed view in FIG. 6.). The phase angle control aims for the proper elimination of the time elapsed between this peak force indicator and the desired one. Further details concerning such phase control is provided in the experimental section set forth below.

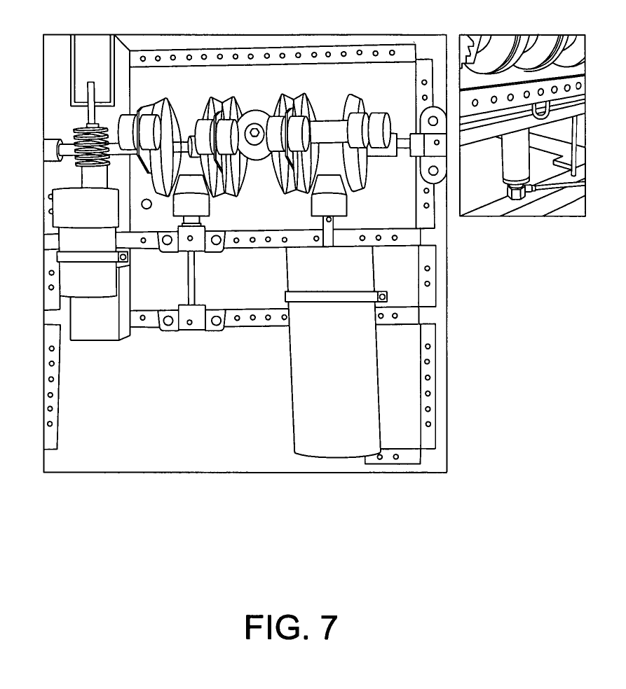

A prototype HFG structure has been constructed according to the present disclosure, and is depicted in an experimental setting in the photographic view of FIG. 7. The prototype HFG structure advantageously demonstrated the feasibility of the disclosed procedure for generating a desired harmonic force. As shown in FIG. 7, the exemplary prototype structure includes two (2) actuators (motors), two (2) sensors (tacho-generator and force sensor), and a photo detector marking the instants when the force peaks appear.

In constructing the prototype HFG structure, the following design parameters and/or equipment components were employed. As will be readily apparent to persons skilled in the art, alternative design parameters and/or equipment components may be employed without departing from the spirit or scope of the present disclosure.

mⱼ=0.1 kg j=1 . . . 4, r=5.5 cm

| | |
|---|---|
| motor #1: | Cleveland Machine Controls. 2600 series, |
| | model MT 2620128EG, peak torque 2.75 Nm |
| motor #2 | Colman LYMC - 63000-731 |
| potentiometer | Helipot 10 turn, 0-50 kΩ |
| force transducer | PCB 208 C02, 50 mV/lbs |
| photo detector | Omron EE-SX673A |

As set forth in the following Table 1, the weight contributions of the various components of the prototype HFG structure depicted in FIG. 7 are summarized.

TABLE 1
The table of the weight inventory

| Item | Weight [kg] | |
|---|---|---|
| Motor #1 | 0.7 | |
| Motor #2 | 0.3 | |
| Centrifugal masses | 0.4 | |
| Gear pairs and shafts | 0.3 | |
| Housing structure | 0.9 | |
| Total | 2.6 | kg |

According to the exemplary prototype HFG structure of the present disclosure, control is performed using a dSPACE digital signal processing card DS1102. D/A mode is used for open loop control and A/D mode for monitoring. Both procedures run at 1000 Hz sampling frequency. Alternative signal processing equipment may be employed, as will be readily apparent to persons skilled in the art.

To further describe the advantageous HFG systems of the present disclosure, two example sets of experiments were conducted and are described below.

i) The combination of C1+C2+C3, i.e., the force frequency, amplitude and the absolute phase, were varied concurrently. The transition time was selected to be two (2) seconds. The initial and final values of the transition were taken as:

$${ω}_{i} = 2 * π * 8.5 \frac{rad}{sec} , {ω}_{f} = 2 * π * 10.5 \frac{rad}{sec}$$

$${\overline{F}}_{peak , i} = 60 N , {\overline{F}}_{peak , f} = 30 N$$

$${θ}_{i} = 0 deg , {θ}_{f} = 180 deg$$

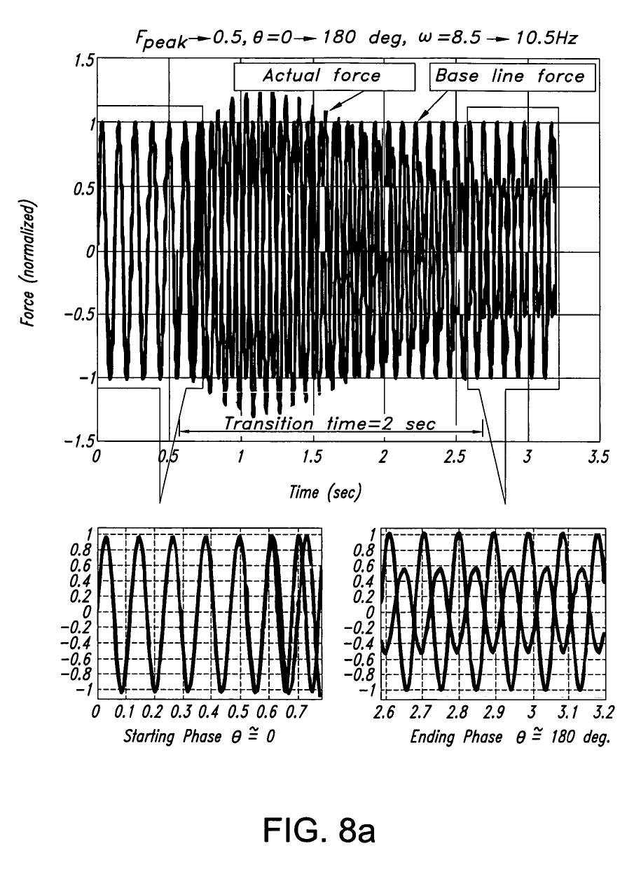

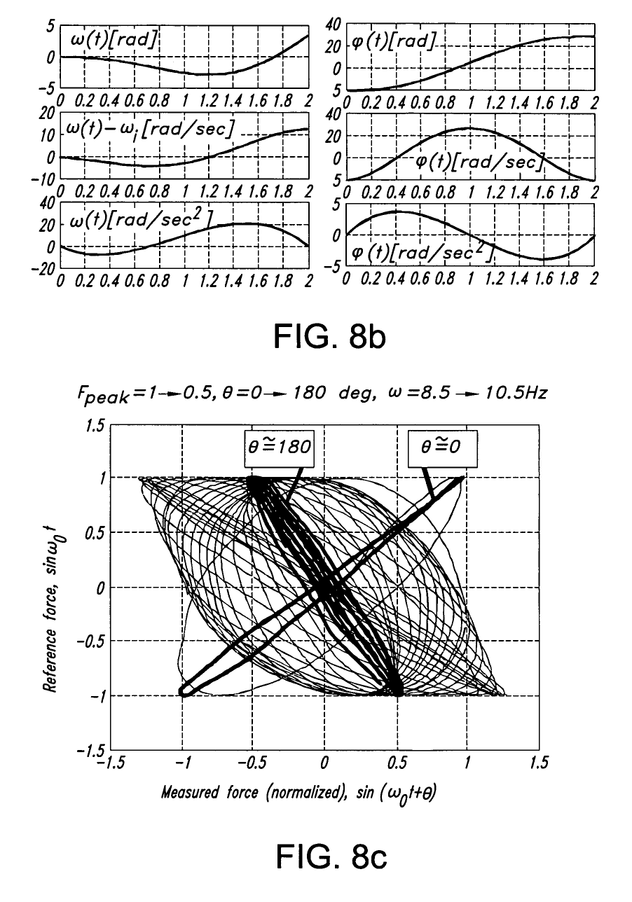

FIG. 8a shows the output traces in the normalized scale for such experimental operation. FIG. 8c forms a Lissajous pattern between the force output and the desired force. It is expected that for θᵢ=0 deg and θ_{f}=180 deg the pattern should form a straight line. The experiment delivers results very close to such straight line. Both transient features were successfully achieved. The desired motion trajectories of motor #1 and #2 are depicted on the FIG. 8b. As reflected in the values of ω(t), φ(t), θ(t), the polynomials satisfy the initial and final values. Of note, the initial and final accelerations are zero (both for \dot{ω} and \ddot{ψ}).

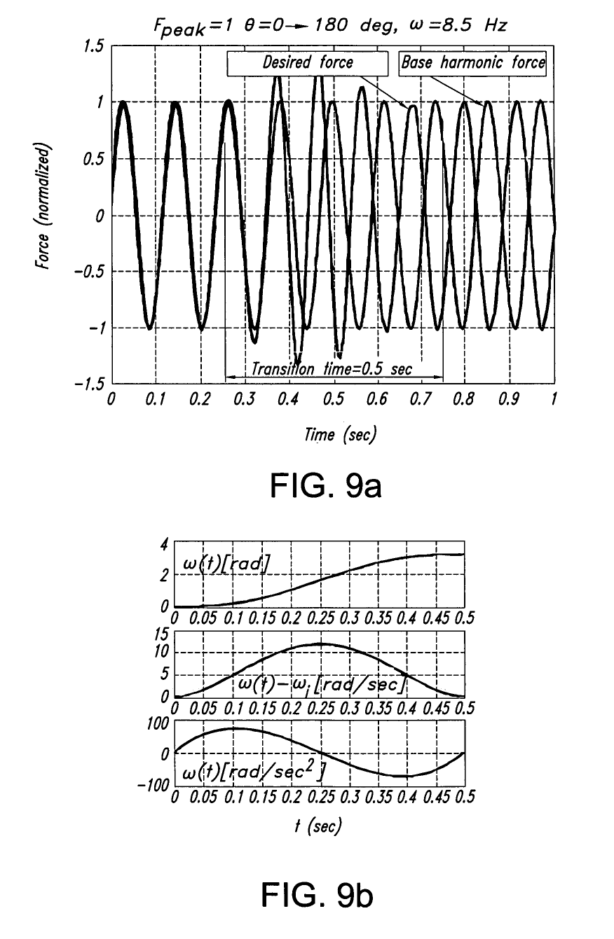

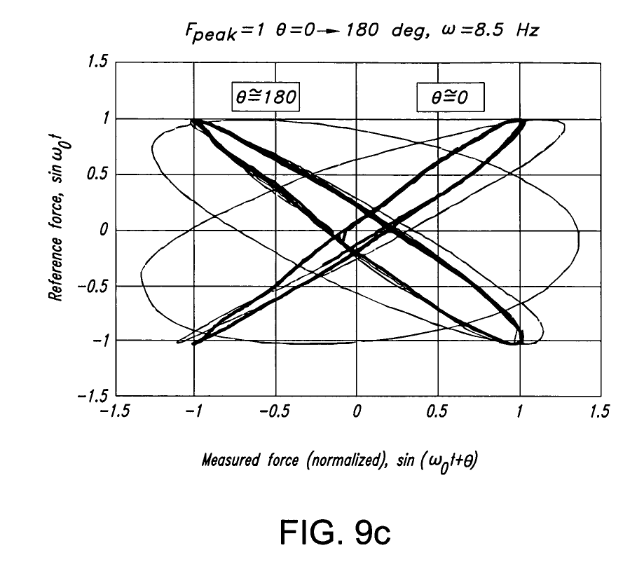

ii) C3 alone at steady ω, i.e., the absolute phase angle of the harmonic force is varied from θᵢ=0 deg to θ_{f}=180 deg while the harmonic force amplitude and its frequency remain unchanged. The baseline harmonic signal is given in FIG. 9a for comparison. The final value of θ is 180 degrees, as desired. This transition requires the ω(t) variation as shown in FIG. 9b. It represents the operation of motor #1. The trajectories satisfy the initial and final values of the transition. Of note, there is no trajectory for motor #2 since it stays motionless in this mode of transition. The accumulated phase change is

$${θ}_{f} - {θ}_{i} = {{\int }_{0}}^{T} ( ω - {ω}_{i} ) ⅆ t$$

which is the equivalent phase shift during the transition.

FIGS. 9a and 9b represent a fast transition which takes approximately 0.5 sec to move from θᵢ=0 deg to θ_{f}=180 deg. The Lissajous pattern shows this transition which takes place without a large overshoot. Of note, the horizontal axis in FIG. 9c represents the actual force amplitude and it is desirable for such amplitude to remain unchanged. The amplitude inevitably shows some overshoot due to the fact that ω is first increased and then decreased to create 180 deg phase (see FIG. 9b). At both ends (start and finish), however, the phase locked feature works quite efficiently and the form of the Lissajous pattern is very flat and very well aligned. This is achieved over the feedback information provided by the pulses coming from the optical sensor.

The force to weight comparison was also evaluated for the prototype HFG structure, as it forms one of the key objectives of the present disclosure. Although the presented laboratory prototype may be further optimized, i.e., it was designed primarily to validate the proposed principles, this particular device is capable of producing forces in maximum frequency of 25 Hz, i.e., with peak force F=545 N. Thus, the “force/weight” ratio is η=20 (see Table 1 for the weight inventory of the most critical components). The comparable reciprocating mass devices on the market have “force/weight” ratios below 5, e.g., Wilcoxon F4/Z280WA (η=0.5), LDS V201/3 (η=1.4), LDS V459/1 (η=0.3), etc. Thus, the disclosed HFGs provide an enhanced force/weight ratio relative to representative commercially available systems.

Thus, a novel harmonic force generator (HFG) is disclosed herein which advantageously controls the amplitude, frequency and then the phase of the resultant output force. The disclosed HFG uses centrifugal forces created by multiple rotating masses of which the relative positions are manipulated. This particular mechanism has two (2) degrees of freedom, which are concurrently controlled, yielding the combined effect for advantageously adjusting the amplitude, frequency and the phase of the resultant harmonic force. These two degrees of freedom are the rotational motions of the two motors. The quality of the trajectory control is monitored using three elements of sensory information: a tacho-generator (sensing the angular velocity of the prime mover, motor #1), a potentiometer (determining the relative angular position of the rotating masses), and a force transducer.

The transition operation from one harmonic force to another is achieved without injecting undue jolts on the two motors at the start and the end of the transition. The total transition period is under the guidance of the controller and it can be made desirably small (limited only by the motor powers). The disclosed HFGs have wide ranging applicability including, for example, in applications involving vibration cancellation/suppression on large bodies (with large inertia) where the weight of the HFG is desired to be small. Exemplary applications include the aerospace industry (e.g., helicopter, aircraft, etc.), the tool industry (e.g., manufacturers of hand tools, particularly those that relatively steady operating frequencies), and the like. The disclosed HFG technology may be implemented in newly constructed/fabricated HFG systems or may be utilized in refurbishing existing equipment.

The disclosed harmonic force generator thus provides for enhanced control and operation, while accommodating desired variations in amplitude, frequency and phase angle. The disclosed harmonic force generator also provides improved transition trajectory, e.g., to prevent controller shocks, and may be operated with an existing prime mover, e.g., based on a rotating shaft input. Exemplary embodiments of the disclosed harmonic force generator are light weight, compact and effective in conserving rotational momentum. The disclosed harmonic force generator also advantageously minimizes total harmonic distortion, e.g., by combating gravity effects.

Although the present disclosure has been described with reference to specific exemplary embodiments thereof, the present disclosure is not to be limited thereby. Rather, modifications, changes and/or enhancements may be undertaken with respect to the disclosed harmonic force generator systems/devices without departing from the spirit or scope of the present disclosure. For example, harmonic force generators may be encased within housings that are fabricated from appropriate materials that serve to further minimize the weight thereof. Additional modifications, changes and/or enhancements may become apparent based on the detailed disclosure provided herewith, and such modifications, changes and/or enhancements are encompassed hereby.

1. An harmonic force generator comprising:
(a) a first motor and a second motor for adjusting at least one of the amplitude, frequency and phase of an harmonic force associated with multiple rotating masses;
(b) one or more sensor mechanisms for sensing information relevant to adjusting at least one of the amplitude, frequency and phase of the harmonic force;
(c) a controller that controls operation of the first and second motors based on the information sensed by the one or more sensor mechanisms.

2. An harmonic force generator according to claim 1, wherein at least one of the first and second motors is a DC servo motor.

3. An harmonic force generator according to claim 1, wherein at least one of the first and second motors is controlled in current mode.

4. An harmonic force generator according to claim 1, wherein the one or more sensor mechanisms are selected from the group consisting of a tacho-generator, a potentiometer, an optical sensor, and combinations thereof.

5. An harmonic force generator according to claim 4, wherein the tacho-generator measures the angular velocity of the first motor.

6. An harmonic force generator according to claim 4, wherein the potentiometer measures the relative angular position of the rotating masses.

7. An harmonic force generator according to claim 4, wherein the optical sensor includes a light emitting diode and a photo detector, and measures force peaks associated with operation of the harmonic force generator.

8. An harmonic force generator according to claim 1, wherein the first motor and second motor provide the harmonic force generator with two degrees of freedom.

9. An harmonic force generator according to claim 1, wherein the controller is effective to transition operation from one harmonic force to another harmonic force without undue jolts on the first and second motors.

10. A method for achieving vibration cancellation, comprising:
(a) providing an harmonic force generator that includes: (i) a first motor and a second motor for adjusting at least one of the amplitude, frequency and phase of an harmonic force associated with multiple rotating masses, (ii) one or more sensor mechanisms for sensing information relevant to adjusting at least one of the amplitude, frequency and phase of the harmonic force, and (iii) a controller that controls operation of the first and second motors based on the information sensed by the one or more sensor mechanisms;
(b) operating the harmonic force generator to achieve vibration cancellation.

11. A method according to claim 10, wherein the vibration cancellation is achieved in an aerospace application.

12. A method according to claim 10, wherein the vibration cancellation is achieved in a hand tool application.
